(19) United States
(12) Patent Application Publication
(10) Pub. No.: US 2016/0179865 A1
(43) Pub. Date: Jun. 23, 2016

(54) METHOD AND SYSTEM FOR CONCURRENCY CONTROL IN LOG-STRUCTURED MERGE DATA STORES

(71) Applicant: Yahoo! Inc., Sunnyvale, CA (US)

(72) Inventors: Edward Bortnikov, Haifa (IL); Guy Gueta, Holon (IL); Eshcar Hillel, Binyamina (IL); Idit Keidar, Haifa (IL)

(21) Appl. No.: 14/573,183

(22) Filed: Dec. 17, 2014

(51) Int. Cl. G06F 17/30

(52) U.S. Cl. CPC G06F 17/30362; G06F 17/30321; G06F 17/30575

(57) ABSTRACT

The present teaching relates to concurrency control in log-structured merge (LSM) data stores. In one example, a call is received from a thread for writing a value to a key of LSM components. A shared mode lock is set on the LSM components in response to the call. The value is written to the key once the shared mode lock is set on the LSM components. The shared mode lock is released from the LSM components after the value is written to the key.

### BACKGROUND

1. Technical Field

The present teaching relates to methods, systems, and programming for log-structured merge (LSM) data stores. More specifically, the present teaching is directed to methods, systems, and programming for concurrency control in LSM data stores.

2. Discussion of Technical Background

Over the last decade, key-value stores have become prevalent for real-time serving of Internet-scale data. Gigantic stores managing billions of items serve Web search indexing, messaging, personalized media, and advertising. A key-value store is a persistent map with atomic get and put operations used to access data items identified by unique keys. Modern stores also support a wide range of application programing interfaces (APIs), such as consistent snapshot scans and range queries for online analytics.

In write-intensive environments, key-value stores are commonly implemented as LSM data stores. The main centerpiece behind such data stores is absorbing large batches of writes in a random-access memory (RAM) data structure that is merged into a (substantially larger) persistent data store on a disk upon spillover. This approach masks persistent storage latencies from the end user, and increases throughput by performing I/O sequentially. A major bottleneck of such data stores is their limited in-memory concurrency, which restricts their vertical scalability on multicore/multiprocessor servers. In the past, this was not a serious limitation, as large Web-scale servers did not harness high-end multicore/multiprocessor hardware. Nowadays, however, servers with more cores have become cheaper, and 16-core machines commonplace in production settings.

The basis for LSM data structures is the logarithmic method. It was initially proposed as a way to efficiently transform static search structures into dynamic ones. Several approaches for optimizing the performance of the general logarithmic method have been proposed in recent years. However, all the known solutions apply conservative concurrency control policies, which prevent them from exploiting the full potential of the multicore/multiprocessor hardware. Moreover, the known solutions typically support only a limited number of APIs. For example, some of those known approaches do not support consistent scans or an atomic read-modify-write (RMW) operation. In addition, each of these known algorithms builds upon a specific data structure as its main memory component.

Therefore, there is a need to provide an improved solution for concurrency control in LSM data stores to solve the above-mentioned problems.

### SUMMARY

The present teaching relates to methods, systems, and programming for LSM data stores. Particularly, the present teaching is directed to methods, systems, and programming for concurrency control in LSM data stores.

In one example, a method implemented on a computing device which has at least one processor and storage for concurrency control in LSM data stores is presented. A call is received from a thread for writing a value to a key of LSM components. A shared mode lock is set on the LSM components in response to the call. The value is written to the key once the shared mode lock is set on the LSM components. The shared mode lock is released from the LSM components after the value is written to the key.

In another example, a method implemented on a computing device which has at least one processor and storage for concurrency control in LSM data stores is presented. A call is received for merging a current memory component of LSM components with a current disk component of the LSM components. An exclusive mode lock is set on the LSM components in response to the call. A pointer to the current memory component and a pointer to a new memory component of the LSM components are updated once the first exclusive mode lock is set on the LSM components. The exclusive mode lock is released from the LSM components after the pointers to the current and new memory components are updated. The current memory component is merged with the current disk component to generate a new disk component of the LSM components. The exclusive mode lock is set on the LSM components once the new disk component is generated. A pointer to the new disk component is updated once the second exclusive mode lock is set on the LSM components. The exclusive mode lock is released from the LSM components after the pointer to the new disk components is updated.

In still another example, a method implemented on a computing device which has at least one processor and storage for concurrency control in LSM data stores is presented. A call is received from a thread for writing a value to a key of LSM components. A shared mode lock is set on the LSM components in response to the call. A time stamp that exceeds the latest snapshot's time stamp is obtained once the shared mode lock is set on the LSM components. The value is written to the key with the obtained time stamp. The shared mode lock is released from the LSM components after the value is written to the key with the obtained time stamp.

In yet another example, a method implemented on a computing device which has at least one processor and storage for concurrency control in LSM data stores is presented. A call is received from a thread for getting a snapshot of LSM components. A shared mode lock is set on the LSM components in response to the call. A time stamp that is earlier than all active time stamps is obtained once the shared mode lock is set on the LSM components. The shared mode lock is released from the LSM components after the time stamp is obtained. The obtained time stamp is returned as a snapshot handle.

In yet another example, a method implemented on a computing device which has at least one processor and storage for concurrency control in LSM data stores is presented. A call is received from a thread for a read-modify-write (RMW) operation to a key with a function in a linked list of a LSM component. A shared mode lock is set on the LSM components in response to the call. An insertion point of a new node for the key is located and stored in a local variable once the shared mode lock is set on the LSM components. Whether another thread inserts a new node for the key during locating and storing the insertion point is determined. If the result of the determining is negative, a succeeding node of the linked list is stored. Whether another thread inserts a new node for the key before storing the succeeding node is checked. If the result of the checking is negative, the new node of the linked list is created for the key, a new time stamp is obtained for the new node, and a new value of the key is set by applying the function to a current value of the key.

Other concepts relate to software for implementing the present teaching on concurrency control in LSM data stores. A software product, in accord with this concept, includes at least one non-transitory machine-readable medium and information carried by the medium. The information carried by the medium may be executable program code data regarding parameters in association with a request or operational parameters, such as information related to a user, a request, or a social group, etc.

In one example, a non-transitory machine readable medium having information recorded thereon for concurrency control in LSM data stores is presented. The recorded information, when read by the machine, causes the machine to perform a series of processes. A call is received from a thread for writing a value to a key of LSM components. A shared mode lock is set on the LSM components in response to the call. The value is written to the key once the shared mode lock is set on the LSM components. The shared mode lock is released from the LSM components after the value is written to the key.

In another example, a non-transitory machine readable medium having information recorded thereon for concurrency control in LSM data stores is presented. The recorded information, when read by the machine, causes the machine to perform a series of processes. A call is received for merging a current memory component of LSM components with a current disk component of the LSM components. An exclusive mode lock is set on the LSM components in response to the call. A pointer to the current memory component and a pointer to a new memory component of the LSM components are updated once the first exclusive mode lock is set on the LSM components. The exclusive mode lock is released from the LSM components after the pointers to the current and new memory components are updated. The current memory component is merged with the current disk component to generate a new disk component of the LSM components. The exclusive mode lock is set on the LSM components once the new disk component is generated. A pointer to the new disk component is updated once the second exclusive mode lock is set on the LSM components. The exclusive mode lock is released from the LSM components after the pointer to the new disk components is updated.

In still another example, a non-transitory machine readable medium having information recorded thereon for concurrency control in LSM data stores is presented. The recorded information, when read by the machine, causes the machine to perform a series of processes. A call is received from a thread for writing a value to a key of LSM components. A shared mode lock is set on the LSM components in response to the call. A time stamp that exceeds the latest snapshot's time stamp is obtained once the shared mode lock is set on the LSM components. The value is written to the key with the obtained time stamp. The shared mode lock is released from the LSM components after the value is written to the key with the obtained time stamp.

In yet another example, a non-transitory machine readable medium having information recorded thereon for concurrency control in LSM data stores is presented. The recorded information, when read by the machine, causes the machine to perform a series of processes. A call is received from a thread for getting a snapshot of LSM components. A shared mode lock is set on the LSM components in response to the call. A time stamp that is earlier than all active time stamps is obtained once the shared mode lock is set on the LSM components. The shared mode lock is released from the LSM components after the time stamp is obtained. The obtained time stamp is returned as a snapshot handle.

In yet another example, a non-transitory machine readable medium having information recorded thereon for concurrency control in LSM data stores is presented. The recorded information, when read by the machine, causes the machine to perform a series of processes. A call is received from a thread for an RMW operation to a key with a function in a linked list of a LSM component. A shared mode lock is set on the LSM components in response to the call. An insertion point of a new node for the key is located and stored in a local variable once the shared mode lock is set on the LSM components. Whether another thread inserts a new node for the key during locating and storing the insertion point is determined. If the result of the determining is negative, a succeeding node of the linked list is stored. Whether another thread inserts a new node for the key before storing the succeeding node is checked. If the result of the checking is negative, the new node of the linked list is created for the key, a new time stamp is obtained for the new node, and a new value of the key is set by applying the function to a current value of the key.

Additional features will be set forth in part in the description which follows, and in part will become apparent to those skilled in the art upon examination of the following and the accompanying drawings or may be learned by production or operation of the examples. The features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts vertical scalability of multi-threading on multicore processors in key-value data stores;

FIG. 2 depicts multi-threads concurrency control in key-value data stores;

FIG. 3 depicts exemplary LSM components;

FIG. 4 depicts an exemplary merge function in LSM data stores;

FIG. 5 is an exemplary diagram of a system for concurrency control in LSM data stores, according to an embodiment of the present teaching;

FIG. 6 is a flowchart of an exemplary process of concurrency control for basis put/get operations in LSM data stores, according to an embodiment of the present teaching;

FIG. 7 is a flowchart of an exemplary process of concurrency control for the merge function in LSM data stores, according to an embodiment of the present teaching;

FIGS. 8-9 depict snapshot time stamp management in concurrency control in LSM data stores, according to an embodiment of the present teaching;

FIG. 10 is a flowchart of an exemplary process of concurrency control for a put operation with time stamp in LSM data stores, according to an embodiment of the present teaching;

FIG. 11 is a flowchart of an exemplary process of concurrency control for a get snapshot operation in LSM data stores, according to an embodiment of the present teaching;

FIG. 12 is a flowchart of an exemplary process of concurrency control for an RMW operation in LSM data stores, according to an embodiment of the present teaching;

FIG. 13 depicts a chart illustrating exemplary experiment results of scalability with production workload;

FIG. 14 depicts charts illustrating exemplary experiment results of write performance;

FIG. 15 depicts charts illustrating exemplary experiment results of read performance;

FIG. 16 depicts charts illustrating exemplary experiment results of throughput in mixed workloads;

FIG. 17 depicts a chart illustrating exemplary experiment results of mixed reads and writes benefit from memory component size with 8 threads;

FIG. 18 depicts a chart illustrating exemplary experiment results of RMW throughput;

FIG. 19 depicts charts illustrating exemplary experiment results of throughput in workloads collected from a production web-scale system;

FIG. 20 depicts a chart illustrating exemplary experiment results of workload with heavy disk-compaction; and

FIG. 21 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of scalable concurrency control in LSM data stores. The method and system as disclosed herein aim at overcoming the vertical scalability challenge on multicore/multiprocessor hardware by exploiting multiprocessor-friendly data structures and non-blocking synchronization techniques. In one aspect of the present teaching, the method and system overcome the scalability bottlenecks incurred in known solutions by eliminating blocking during normal operation. The method and system do not explicitly block get operations and block put operations for short periods of time before and after a batch I/Os.

In another aspect of the present teaching, the method and system support a rich APIs, including for example, snapshots, iterators (snapshot scans), and general non-blocking RMW operations. Beyond atomic put and get operations, the method and system also support consistent snapshot scans, which can be used to provide range queries. These are important for applications such as online analytics and multi-object transactions. In addition, the method and system support fully-general non-blocking atomic RMW operations. Such operations are useful, e.g., for multisite update reconciliation.

In still another aspect of the present teaching, the method and system are generic to any implementation of LSM data stores that combines disk-resident and memory-resident components. The method and system for supporting puts, gets, snapshot scans, and range queries are decoupled from any specific implementation of the LSM data stores' main building blocks, namely the in-memory component (a map data structure), the disk store, and the merge function that integrates the in-memory component into the disk store. Only the support for atomic RMW requires a specific implementation of the in-memory component as a linked list data structure. This allows one to readily benefit from numerous optimizations of other components (e.g., disk management).

Features involved in the present teaching include, for example: all operations that do not involve I/O are non-blocking; unlimited number of atomic read and write operations can execute concurrency; snapshot and iterator operations can execute concurrently with atomic read and write operations; RMW operations are implemented in an atomic efficient lock-free way and can execute concurrently with other operations; the method and system can be applied to any implementation of LSM data stores that combine disk-resident and memory-resident components.

Moreover, the method and system in the present teaching achieve substantial performance gains in comparison with the known solutions under any CPU- or RAM-intensive work load, for example, in write-intensive workloads, read-intensive workloads with substantial locality, RMW workloads with substantial locality, etc. In the experiments, the method and system in the present teaching achieve performance improvements ranging between 1.5× and 2.5× over some known solutions on a variety of workloads. RMW operations are also twice as fast as a popular implementation based on lock striping. Furthermore, the method and system in the present teaching exhibit superior scalability, successfully utilizing at least twice as many threads, and also benefits more from a larger RAM allocation to the in-memory component.

In key-value stores, the data is comprised of items (rows) identified by unique keys. A row value is a (sparse) bag of attributes called columns. The basic API of a key-value store includes put and get operations to store and retrieve values by their keys. Updating a data item is cast into putting an existing key with a new value, and deleting one is performed by putting a deletion marker “⊥” as the key's value. To cater to the demands of online analytics applications, key-value stores typically support snapshot and iterator (snapshot scan) operations, which provide consistent read-only views of the data. A snapshot allows a user to read a selected set of keys consistently. A scan allows the user to acquire a snapshot of the data (getSnap), from which the user can iterate over items in lexicographical order of their keys by applying next operations. Geo-replication scenarios drive the need to reconcile conflicting replicas. This is often done through vector clocks, which require the key-value store to support conditional updates, namely, atomic RMW operations.

Distributed key-value stores achieve scalability by sharding data into units called partitions (also referred to as tablets or regions). Partitioning provides horizontal scalability—stretching the service across multiple servers. Nevertheless, there are penalties associated with having many partitions: First, the data store's consistent snapshot scans do not span multiple partitions. Analytics applications that require large consistent scans are forced to use costly transactions across shards. Second, this requires a system-level mechanism for managing partitions, whose meta-data size depends on the number of partitions, and can become a bottleneck.

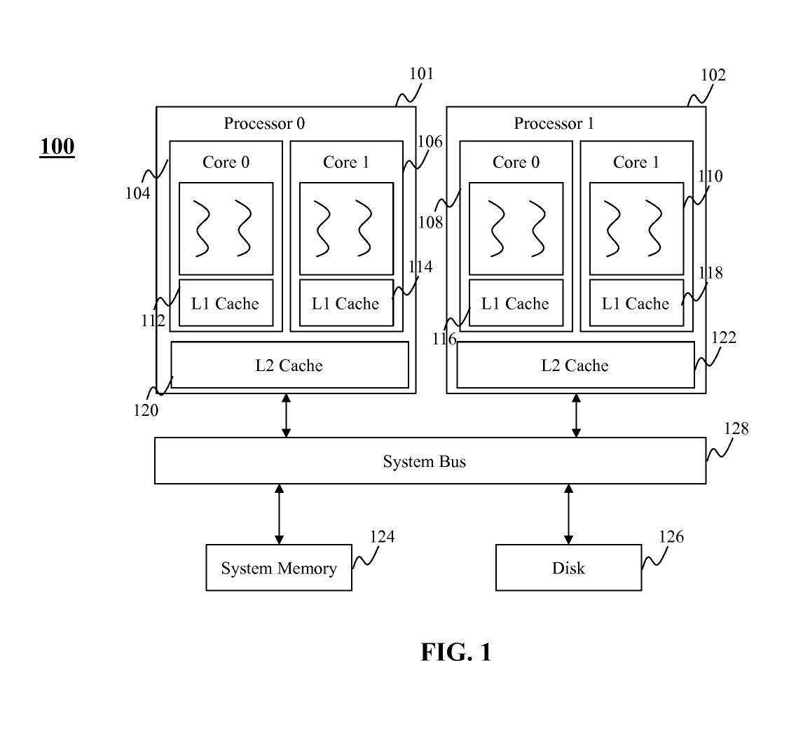

The complementary approach of increasing the serving capacity of each individual partition is called vertical scalability. FIG. 1 depicts vertical scalability of multi-threading on multicore processors in key-value data stores. The system 100 in this example is a single multiprocessor machine with two processors 101, 102. Each processor 101, 102 may be a multicore processor, including multiple cores 104, 106, 108, 110, L1 caches 112, 114, 116, 118, and L2 caches 120, 122. Each core may feature two hardware threads and any number of software threads that can concurrently access the same data item(s) in a system memory 124 and/or on a disk 126 in parallel through a system bus 128. In one example, the system 100 may be a Xeon E5620 server with two quad-core CPUs, a 48 GB of RAM, and directly-attached 720 GB of SSD storage with RAID-5 protection.

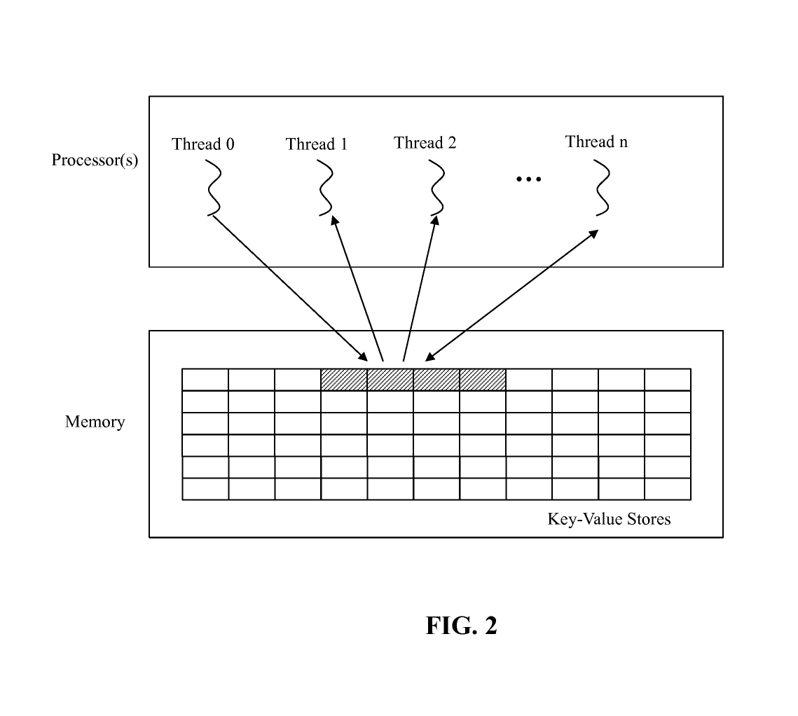

It is understood that nowadays, increasing the serving capacity of every individual partition server (i.e., vertical scalability), e.g., by increasing the number of cores, becomes essential. First, this necessitates optimizing the speed of I/O bound operations. The leading approach to do so, especially in write-intensive settings, is LSM, which effectively eliminates the disk bottleneck. Once this is achieved, the rate of in-memory operations becomes paramount. Another concern is the concurrency control. As shown in FIG. 2, multiple software threads 0-n may access to the same data items (e.g., key-value pairs in key-value stores) at the same time via various operations, e.g., puts, gets, RMWs, etc. Thus, concurrency control is essential in vertical scalability to ensure that the increasing number of concurrent transactions do not violate the data integrity of the data stores.

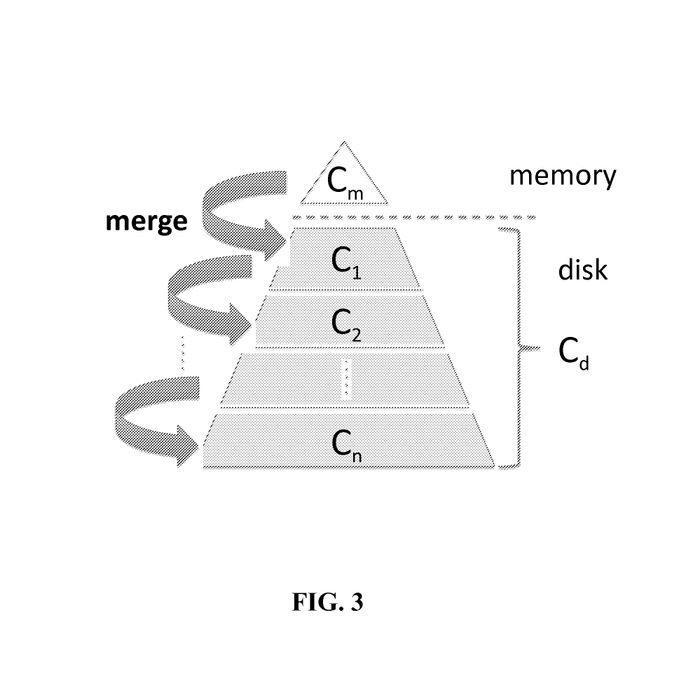

FIG. 3 depicts exemplary LSM components. The LSM data store solution, which batches write operations in memory and merges them with on-disk storage in the background, has become the today's leading key-value stores. An LSM data store organizes data in a series of components of increasing sizes, as illustrated in FIG. 3. The first component, Cm, is an in-memory sorted map that contains most-recent data. The rest of the components C1, . . . , Cn resides on disk. For simplicity, in the present teaching, C1, . . . , Cn are perceived as a single component, Cd. Another building block in LSM data stores is the merge function/procedure, (sometimes called compaction), which incorporates the contents of the memory component into the disk, and the contents of each component into the next one.

In LSM data stores, the put operation inserts a data item into the main memory component Cm, and logs it in a sequential file for recovery purposes. Logging can be configured to be synchronous (blocking) or asynchronous (non-blocking) The common default is asynchronous logging, which avoids waiting for disk access, at the risk of losing some recent writes in case of a crash.

When Cm reaches its size limit, which can be hard or soft, it is merged with component Cd, in a way reminiscent of merge sort: The items of both Cm and Cd, are scanned and merged. The new merged component is then migrated to disk in bulk fashion, replacing the old component. When considering multiple disk components, Cm is merged with component C1. Similarly, once a disk component Ci becomes full its data is migrated to the next component Ci+1. Component merges are executed in the background as an automatic maintenance service.

In LSM data stores, the get operation may require going through multiple components until the key is found. But when get operations are applied mostly to recently inserted keys, the search is completed in Cm. Moreover, the disk component utilizes a large RAM cache. Thus, in workloads that exhibit locality, most requests that do access Cd are satisfied from RAM as well.

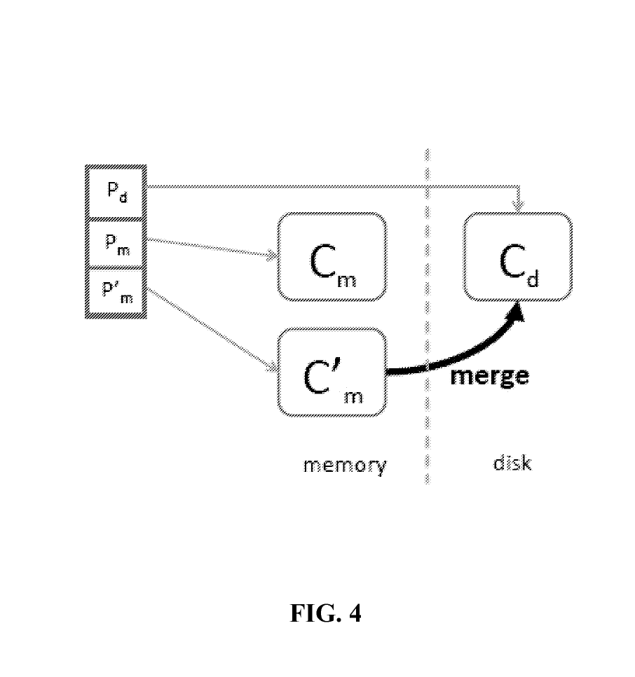

FIG. 4 depicts an exemplary merge function in LSM data stores. During a merge, the memory component becomes immutable, at which point it is denoted as C′m. To allow put operations to be executed while rolling the merge, a new memory component Cm then becomes available for updates. The put and get operations access the components through three global pointers: pointers Pm and P′m to the current (mutable) and previous (immutable) memory components, respectively, and pointer Pd to the disk component. When the merge is complete, the previous memory component C′m is discarded. Allowing multiple put and get operations to be executed in parallel is discussed below in details.

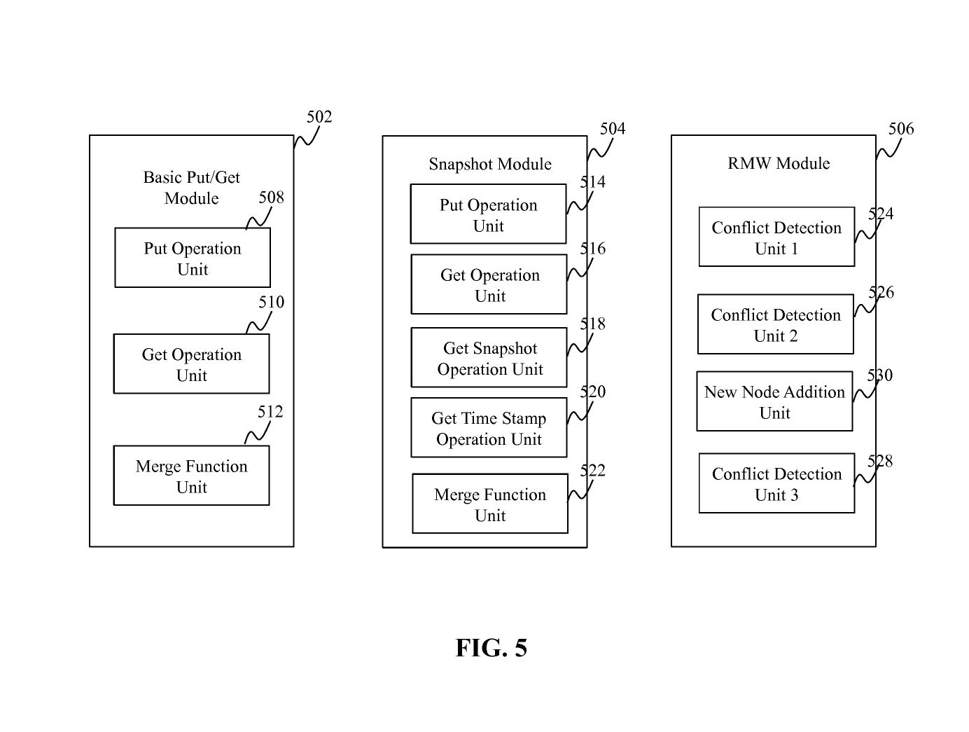

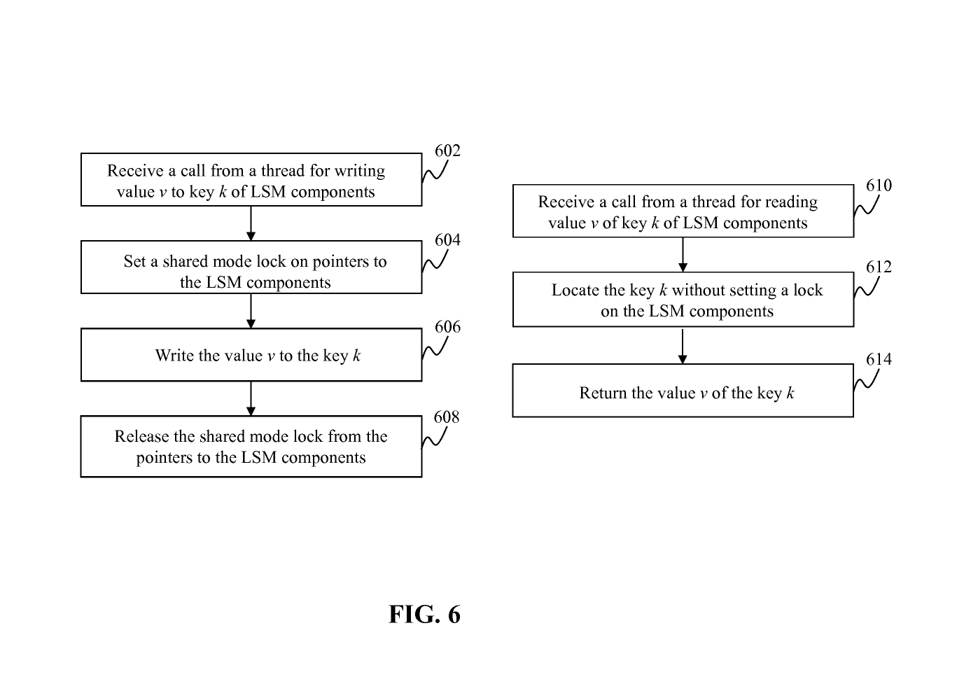

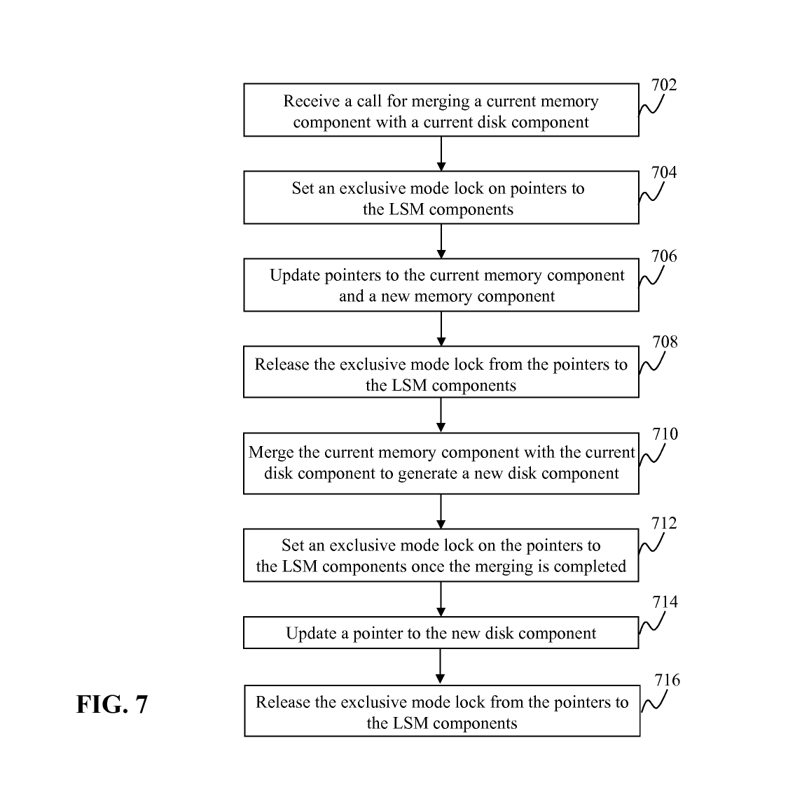

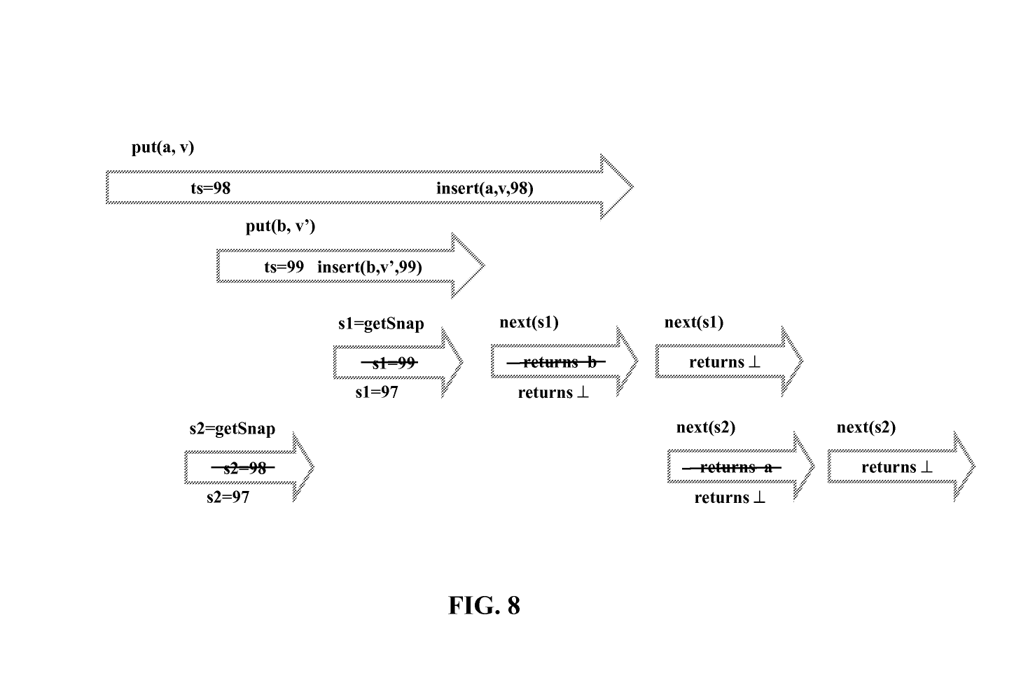

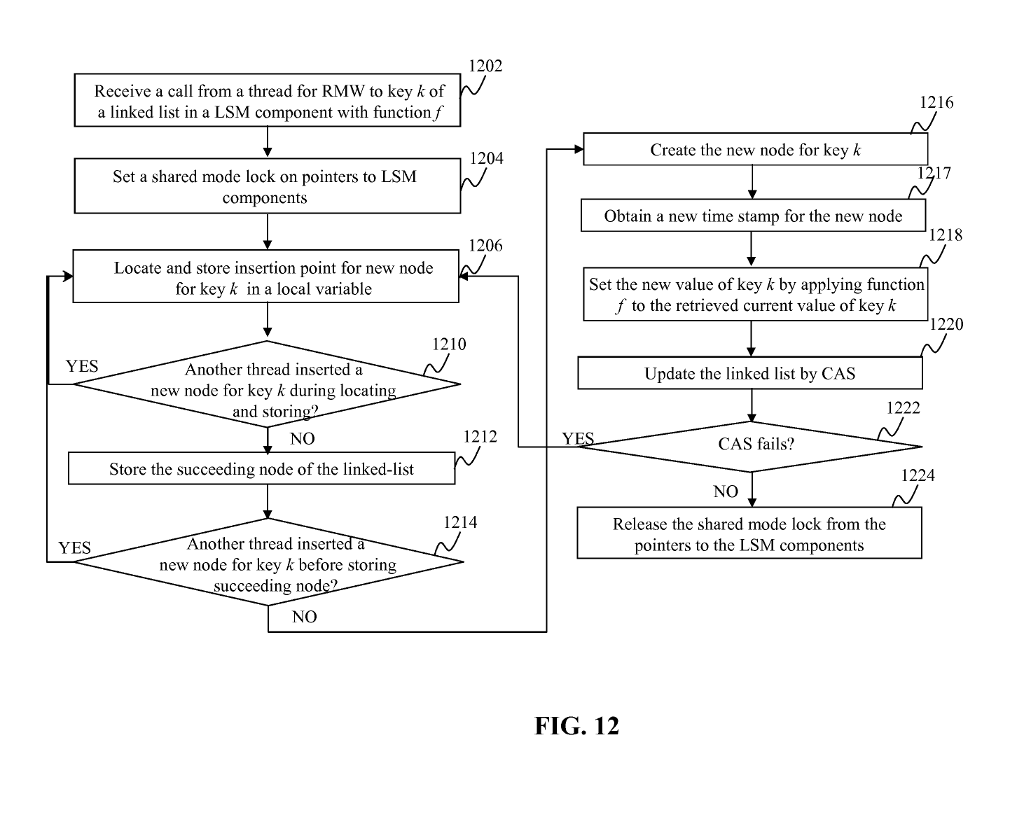

FIG. 5 is an exemplary diagram of a system for concurrency control in LSM data stores, according to an embodiment of the present teaching. The system optimizes in-memory access in the LSM data store, while ensuring correctness of the entire data store. For example, if the in-memory component's operation ensures serializability, then the same is guaranteed by the resulting LSM data store. The system in this embodiment includes a basis put/get module 502, a snapshot module 504, and an RMW module 506. The basis put/get module 502 provides scalable concurrent get and put operations, which is a generic module that can be integrated with any suitable LSM data store implementations. The basis put/get module 502 in this embodiment includes a put operation unit 508, a get operation unit 510, and a merge function unit 512. The details of the basis put/get module 502 are described below with respect to FIGS. 6-7. The snapshot module 504 supports scalable concurrent snapshot and iterator operations. In this embodiment, the snapshot module 504 assumes that the in-memory data structure supports ordered iterated access with weak consistency, as various known in-memory data structures do. The snapshot module 504 in this embodiment includes a put operation unit 514, a get operation unit 516, a get snapshot operation (getSnap) unit 518, a get time stamp (getTS) operation unit 520, and a merge function unit 522. The details of the snapshot module 504 are described below with respect to FIGS. 8-11. The RMW module 506 provides general-purpose non-blocking atomic RMW operations, which are supported in the context of a specific implementation of the in-memory store as a skip-list data structure (or any collection of sorted linked lists). The RMW module 506 in this embodiment includes three conflict detection units 524, 526, 528, and a new node addition unit 530. The details of the RMW module 506 are described below with respect to FIG. 12.

The concurrency control of basis put and get operations in LSM data stores implemented by the basis put/get module 502 is described below in details. A thread-safe map data structure for the in-memory component is assumed in this embodiment. That is, the operations applied to the data structure in the in-memory component can be executed by multiple threads concurrently. Any known data structure implementations that provide this functionality in a non-blocking and atomic manner can be applied in this embodiment. In order to differentiate the interface of the internal map data structure from that of the entire LSM data stores, the corresponding functions of the in-memory data structure are referred in the present teaching as “insert” and “find”: insert (k, v)—inserts the key-value pair (k, v) into the map. If k exists, the value associated with it is overwritten; find (k)—returns a value v such that the map contains an item (k, v), or ⊥ if no such value exists.

In this embodiment, the disk component and merge function may be implemented in an arbitrary way. The concurrency support for the merge function in this embodiment may be achieved by the merge function unit 512 and implemented in two procedures: beforeMerge and afterMerge, which are executed immediately before and immediately after the merge process, respectively. The merge function returns a pointer to the new disk component, N_{d}, which is passed as a parameter to afterMerge. The global pointers Pₘ, P′ₘ, to the memory components, and P_{d} to the disk component, are updated during beforeMerge and afterMerge procedures.

In this embodiment, put and get operations access the in-memory component directly. Get operations that fail to find the requested key in the current in-memory component search the previous one (if it exists) and then the disk store. As insert and find are thread-safe, so put and get operations do not need to be synchronized with respect to each other. However, synchronizing between the update of global pointers and normal operation is needed.

In this embodiment, no synchronization is needed for get operations. This is because the access to each of the pointers is atomic (as it is a single-word variable). The order in which components are traversed in search of a key follows the direction in which the data flows (from Pₘ to P′ₘ, and from there to P_{d}) and is the opposite of the order in which the pointers are updated in beforeMerge and afterMerge procedures. Therefore, if the pointers change after a get operation has searched the component pointed by Pₘ or P′ₘ, then it will search the same data twice, which may be inefficient, but does not violate safety. Following the pointer update, reference counters may be used to avoid freeing memory components that are still being accessed by live read operations.

In this embodiment, for put operations, insertion to obsolete in-memory components needs to be avoided. This is because such insertions may be lost in case the merge process has already traversed the section of the data structure where the data is inserted. To this end, a shared-exclusive lock (sometimes called readers-writer lock) is used in this embodiment in order to synchronize between put operations and the global pointers' update in beforeMerge and afterMerge procedures. Such a lock does not block shared lockers as long as no exclusive locks are requested. In this embodiment, the lock is acquired in shared mode during the put procedure, and in exclusive mode during beforeMerge and afterMerge procedures. In order to avoid starvation of the merge process, the lock implementation is exclusive locking in this embodiment for merge function. Any known shared-exclusive lock implementation may be applied in this embodiment.

In one example, an algorithm is implemented by the four procedures in Algorithm 1 below:

Algorithm 1

```
  1. procedure PUT(Key k , Value v)
  2.  Lock.lockSharedMode( )
  3.  Pₘ.insert(k, t)
  4.  Lock.unlock( )
  5. procedure GET(Key k)
  6.  v ← find k in Pₘ, P′ₘ or P_{d}, in this order
  7.  return v
  8. procedure BEFOREMERGE
  9. Lock.lockExclusiveMode( )
10.  P′ₘ ← Pₘ
11.  Pₘ ← new in-memory component
12.  Lock.unlock( )
13.  procedure AFTERMERGE(DiskComp N_{d})
14.  Lock.lockExclusiveMode( )
15.  P_{d} ← N_{d}
16.  P′ₘ ← ⊥
17.  Lock.unlock( )
```

FIG. 6 is a flowchart of an exemplary process of concurrency control for basis put/get operations in LSM data stores, according to an embodiment of the present teaching. At 602, a call from a thread for writing a value v to a key k of LSM components is received. The key k is in a data item of the in-memory component. At 604, in response to the call, a shared mode lock is set on the LSM components. For example, the shared mode lock is set on global pointers to each of the LSM components, including the memory component(s) and disk component(s). At 606, once the shared mode lock is set on the LSM components, the value v is written to the key k. After the value v is written to the key k, at 608, the shared mode lock is released from the LSM components. For example, the shared mode lock is released from the global pointers to each of the LSM components. Blocks 602-608 correspond to the put operation unit 508 in the basis put/get module 502 and lines 1-4 of Algorithm 1.

At 610, a call from a thread for reading the value v of the key k is received. At 612, the key k is located from a current memory component, a previous memory component, or a disk component of the LSM components, in this order, without setting a lock on the LSM components. That is, the get operations are not blocked. At 614, the value v of the located key k is returned. Blocks 610-614 correspond to the get operation unit 510 in the basis put/get module 502 and lines 5-7 of Algorithm 1.

FIG. 7 is a flowchart of an exemplary process of concurrency control for the merge function in LSM data stores, according to an embodiment of the present teaching. At 702, a call for merging a current memory component with a current disk component is received. At 704, in response to the call, a first exclusive mode lock is set on the LSM components. For example, the first exclusive mode lock is set on global pointers to each of the LSM components, including memory component(s) and disk component(s), in order to synchronize the global pointers' update during short intervals before and after the merge occurs. At 706, the pointer to the current memory component and the pointer to a new memory component are updated once the first exclusive mode lock is set on the LSM components. At 708, after the pointers are updated at 706, the first exclusive mode lock is released from the LSM components. At 710, the current memory component is merged with the current disk component to generate a new disk component. At 712, once the new disk component is generated, i.e., the merge being complete, a second exclusive mode lock is set on the LSM components, for example, all the global pointers. At 714, the pointer to the new disk component is updated. The pointer to the current memory component (now becomes the previous memory component) may be removed as well. At 716, after the pointers are updated, the second exclusive mode lock is released from the LSM components. Blocks 702-716 correspond to the merge function unit 512 in the basis put/get module 502 and lines 8-17 of Algorithm 1.

The concurrency control of snapshot and snapshot scan operations in LSM data stores implemented by the snapshot module 504 is described below in details. Serializable snapshot and snapshot scan operations may be implemented using the common approach of multi-versioning: each key-value pair is stored in the map together with a unique, monotonically increasing, time stamp. That is, the items stored in the underlying map are now key-time stamp-value triples. The time stamps are internal, and are not exposed to the LSM data store's application. In this embodiment, the underlying map is assumed to be sorted in the lexicographical order of the key-time stamp pair. Thus, find operations can return the value associated with the highest time stamp for a given key. It is further assumed that the underlying map provides iterators with the so-called weak consistency property, which guarantees that if an item is included in the data structure for the entire duration of a complete snapshot scan, this item is returned by the scan. Any known map data structures and data stores that support such sorted access and iterators with weak consistency may be applied in this embodiment.

To support multi-versioning, a put operation acquires a time stamp before inserting a value into the in-memory component. This can be done by atomically incrementing and reading a global counter, timeCounter; non-blocking implementations of such counters are known in the art. A get operation now returns the highest time-stamped value (most-recent time stamp) for the given key. A snapshot is associated with a time stamp, and contains, for each key, the latest value updated up to this time stamp. Thus, although a snapshot scan spans multiple operations, it reflects the state of the data at a unique point in time. The obtaining of the most recent time stamp is achieved by, for example, the get time stamp operation unit 502 of the snapshot module 504 in FIG. 5.

In this embodiment, the get snapshot operation (getSnap) returns a snapshot handle s, over which subsequent operations may iterate. The snapshot handle may be a time stamp ts. A scan iterates over all live components (one or two memory components and the disk component) and filters out items that do not belong to the snapshot: for each key k, the next operation filters out items that have higher time stamps than the snapshot time, or are older than the latest timestamp (of key k) that does not exceed the snapshot time. When there are no more items in the snapshot, next returns ⊥.

One example of the snapshot management algorithm is shown in Algorithm 2 below:

Algorithm 2

```
  1. procedure PUT(Key k, Value v)
  2.  Lock.lockSharedMode( )
  3.  ts ← getTS( )
  4.  Pₘ.insert(k, ts, v)
  5.  Active.remove(ts)
  6.  Lock.unlock( )
  7. procedure GETSNAP
  8.  Lock.lockSharedMode( )
  9.  ts ← timeCounter.get( )
10.  tsₐ ← Active.tindMin( )
11.  if tsₐ ≠ ⊥ then ts ← tsₐ − 1
12.  atomically assign max(ts, snapTime) to snapTime
13.  ts_{b} ← snapTime
14.  install ts_{b} in the active snapshot list
15.  Lock.unlock( )
16.  return ts_{b}
17. procedure GETTS
18. while true do
19.  ts ← timeCounter.incAndGet( )
20.  Active.add(ts)
21.  if ts ≦ SsnapTime then Active.remove(ts)
22.  else break
23. return ts
24. procedure BEFOREMERGE
25. Lock.lockExclusiveMode()
26. P′ₘ ← Pₘ
27. Pₘ ← new in-memory component
28. ts ← find minimal active snapshot timestamp
29. Lock.unlock( )
30. return ts
```

In the absence of concurrent operations, the time stamp of a snapshot may be determined by simply reading the current value of the global counter. However, in the presence of concurrency, this approach may lead to inconsistent scans, as illustrated in FIG. 8. In this example, next operations executed in snapshot s2, which reads 98 from timeCounter, filter out a key written with time stamp 99, while next operations executed in snapshot sl, which reads time stamp 99, read this key, but miss a key written with time stamp 98. The latter is missed because the put operation writing it updates timeCounter before the getSnap operation, and inserts the key into the underlying map after the next operation is completed. This violates serializability as there is no way to serialize the two scans. In FIG. 8, snapshots s1 and s2 cannot use the current values of timeCounter, 99 and 98, respectively, since a next operation pertaining to snapshot s1 may miss the concurrently written key a with time stamp 98, while a next operation pertaining to snapshot s1 filters out the key b with time stamp 99. The snapshot time should instead be 97, which excludes the concurrently inserted keys.

This problem may be remedied in this embodiment by tracking time stamps that were obtained but possibly not yet written. In this embodiment, those time stamps are kept in a set data structure, Active, which can be implemented in a non-blocking manner. The getSnap operation chooses a time stamp that is earlier than all active ones. In the above example of FIG. 8, since both 98 and 99 are active at the time s1 and s2 are invoked, they choose 97 as their snapshot time.

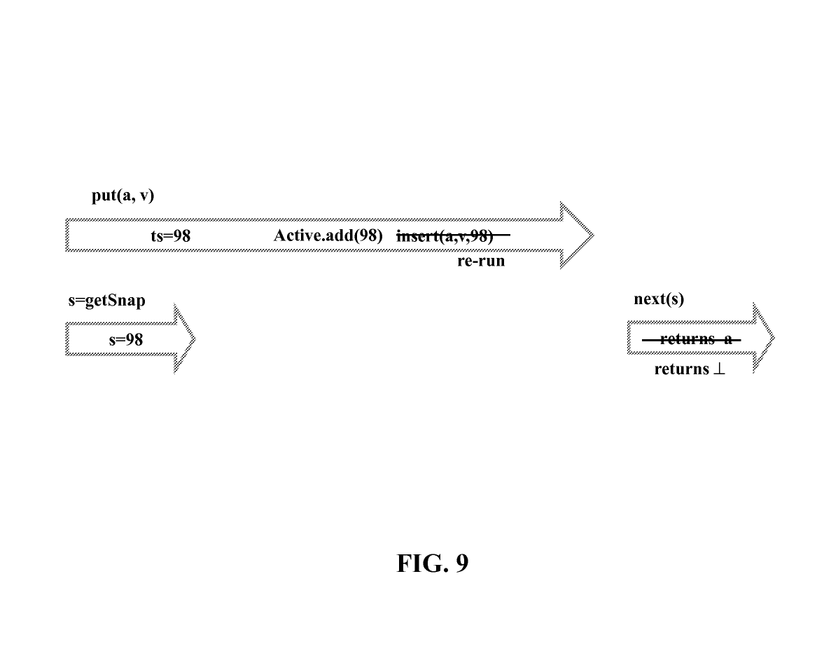

Note that a race can be introduced between obtaining a time stamp and inserting it into Active as depicted in FIG. 9. In this example, a put operation reads time stamp 98 from timeCounter, and before it updates the Active set to include it, a getSnap operation reads time stamp 98 from timeCounter and finds the Active set empty. The snapshot time stamp is therefore set to 98. The value later written by the put operation is not filtered out by the scan, which may lead to inconsistencies, as in the previous example in FIG. 8. To overcome this race, the put operation verifies that its chosen time stamp exceeds the latest snapshot's time stamp (tracked in the snapTime variable), and restarts if it does not. In FIG. 9, the put operation cannot use the value 98 since a snapshot operation already assumes there are no active put operations before time stamp 99. Using the time stamp 98 may lead to the problem depicted in FIG. 8. The put operation should instead acquire a new time stamp.

It is noted that the scan in this embodiment is serializable but not linearizable, in the sense that it can read a consistent state “in the past.” That is, it may miss some recent updates, (including ones written by the thread executing the scan). To preserve linearizability, in some embodiments, the getSnap operation could be modified to wait until it is able to acquire a snapTime value greater than the timeCounter value at the time the operation started.

Since put operations are implemented as insertions with a new time stamp, the key-value store potentially holds many versions for a given key. Following standard practice in LSM data stores, old versions are not removed from the memory component, i.e., they exist at least until the component is discarded following its merge into the disk. Obsolete versions are removed during a merge once they are no longer needed for any snapshot. In other words, for every key and every snapshot, the latest version of the key that does not exceed the snapshot's time stamp is kept.

To consolidate with the merge operation, getSnap installs the snapshot handle in a list that captures all active snapshots. Ensuing merge operations query the list to identify the maximal time stamp before which versions can be removed. To avoid a race between installing a snapshot handle and it being observed by a merge, the data structure may be accessed while holding the lock. In this embodiment, the getSnap operation acquires the lock in shared mode while updating the list, and beforeMerge queries the list while holding the lock in exclusive mode. The time stamp returned by beforeMerge is then used by the merge operation to determine which elements can be discarded. It is assumed that there is a function that can remove snapshots by removing their handles from the list, either per a user's request, or based on time to live (TTL).

Because more than one getSnap operation can be executed concurrently, in this embodiment, snapTime is updated while ensuring that it does not move backward in time. In line 12 of Algorithm 2, snapTime is atomically advanced to is (e.g., using a compare-and-swap “CAS” operation). The rollback loop in get time stamp operation (getTS) may cause the starvation of a put operation. It is noted, however, that each repeated attempt to acquire a time stamp implies the progress of some other put and getSnap operations, as expected in non-blocking implementations.

In this embodiment, a full snapshot scan traverses all keys starting with the lowest and ending with the highest one. More common are partial scans, (e.g., range queries), in which the application only traverses a small consecutive range of the keys, or even simple reads of a single key from the snapshot. In some embodiments, the snapshot module 504 supports these by using a seek function to locate the first entry to be retrieved.

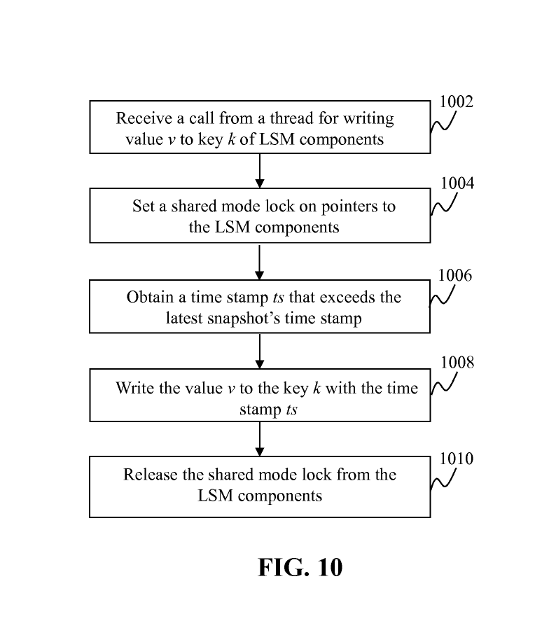

FIG. 10 is a flowchart of an exemplary process of concurrency control for a put operation with time stamp in LSM data stores, according to an embodiment of the present teaching. At 1002, a call from a thread for writing a value v to a key k of LSM components is received. At 1004, in response to the call, a shared mode lock is set on the LSM components. For example, the shared mode lock is set on global pointers to each of the LSM components, including the memory component(s) and disk component(s). At 1006, once the shared mode lock is set on the LSM components, a time stamp ts that exceeds the latest snapshot's time stamp is obtained. Block 1006 may be implemented by the get time stamp operation unit 520 of the snapshot module 504 in FIG. 5. At 1008, the value v is written to the key k with the obtained time stamp ts. After the value v is written to the key k, the shared mode lock is released from the LSM components at 1010. For example, the shared mode lock is released from the global pointers to each of the LSM components. Blocks 1002-1010 correspond to the put operation unit 514 in the snapshot module 504 and lines 1-6 of Algorithm 2.

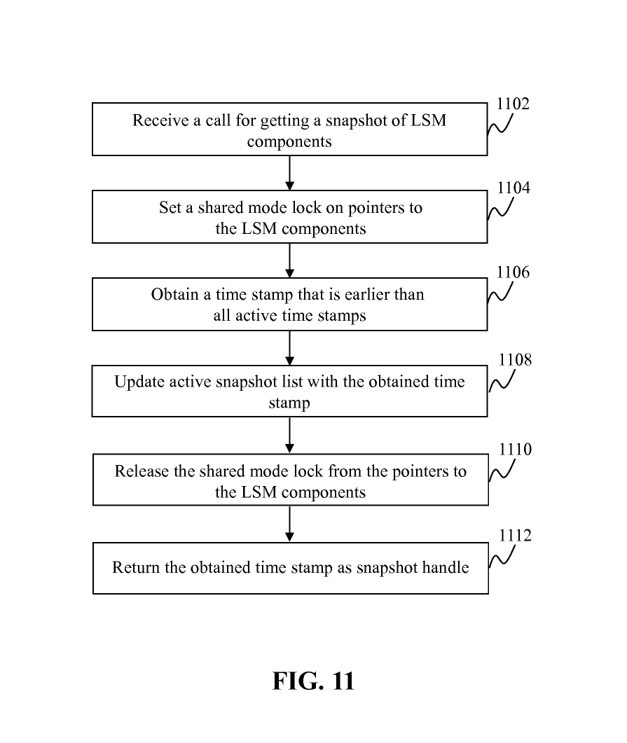

FIG. 11 is a flowchart of an exemplary process of concurrency control for a get snapshot operation in LSM data stores, according to an embodiment of the present teaching. At 1102, a call for getting a snapshot of LSM components is received. At 1104, in response to the call, a shared mode lock is set on the LSM components. For example, the shared mode lock is set on global pointers to each of the LSM components, including the memory component(s) and disk component(s). At 1106, a time stamp that is earlier than all active time stamps is obtained. A time stamp is active if a thread that adds the time stamp is still running, i.e., its addition is not complete. At 1108, an active snapshot list is updated with the obtained time stamp. It is understood that 1108 is optional in some embodiments. At 1110, after the active snapshot list is updated, the shared mode lock is released from the LSM components. For example, the shared mode lock is released from the global pointers to each of the LSM components. At 1112, the obtained time stamp is returned as the snapshot handle. Blocks 1102-1112 correspond to the get snapshot operation unit 518 in the snapshot module 504 and lines 7-16 of Algorithm 2. The get time stamp operation unit 520 in the snapshot module 504 is used in updated operations and corresponds to lines 17-23 of Algorithm 2. The merge function unit 522 in the snapshot module 504 corresponds to lines 24-30 of Algorithm 2 (beforeMerge part) and lines 13-17 of Algorithm 1 (afterMerge part).

The concurrency control of RMW operations in LSM data stores implemented by the RMW module 506 is described below in details. The RMW operations in this embodiment atomically apply an arbitrary function f to the current value v associated with key k and stores f(v) in its place. Such operations are useful for many applications, ranging from simple vector clock update and validation to implementing full-scale transactions. The concurrency control of RMW operations in this embodiment is efficient and avoids blocking. It is given in the context of a specific implementation of the in-memory data store as a linked list or any collection thereof, e.g., a skip-list. Each entry in the linked list contains a key-time stamp-value triple, and the linked list is sorted in the lexicographical order. In a non-blocking implementation of such a data structure, the put operation updates the next pointer of the predecessor of the inserted node using a CAS operation.

One example of the pseudo-code for RMW operations on an in-memory linked list is shown in Algorithm 3 below:

Algorithm 3

| 1. procedure RMW(Key k, Function ƒ) | |
|---|---|
| 2. Lock.lockSharedMode( ) | |
| 3. repeat | |
| 4. find (k, ts, v) with highest ts in Pₘ, P′ₘ, or P_{d} | |
| 5. prev ← Pₘ node with max (k′, ts′) ≦ (k, ∞) | |
| 6. if prev.key = k and prev.time > ts then continue [symbol] conflict | |
| 7. succ ← prev.next | |
| 8. if succ.key = k then continue | [symbol] conflict |
| 9. tsₙ ← getTS( ) | |
| 10. create newNode with (k, tsₙ,ƒ(v)) | |
| 11. newNode.next ← succ | |
| 12. ok ← CAS(prev.next, succ, newNode) | |
| 13. if [symbol] ok then Active remove(tsₙ) | [symbol] conflict |
| 14. until ok | |
| 15. Active.remove(tsₙ) | |
| 16. Lock.unlock( ) | |

Optimistic concurrency control is used in this embodiment—having read v as the latest value of key k, the attempt to insert f(v) fails (and restarts) in case a new value has been inserted for k after v. This situation is called a conflict, and it means that some concurrent operation has interfered between the read step in line 4 and the update step in line 12 of Algorithm 3.

The challenge is to detect conflicts efficiently. In this embodiment, Algorithm 3 takes advantage of the fact that all updates occur in RAM, ensuring that all conflicts will be manifested in the in-memory component. Algorithm 3 further exploits the linked list structure of this component. In line 5 of Algorithm 3, the insertion point for the new node is located and stored in prey. If prey is a node holding key k and a time stamp higher than ts, then it means that another thread has inserted a new node for k between lines 4 and 5 of Algorithm 3—this conflict is detected in line 6 of Algorithm 3. In line 8 of Algorithm 3, a conflict that occurs when another thread inserts a new node for the key k between lines 5 and 7 of Algorithm 3 may be detected—this conflict is observed when succ is a node holding key k. If the conflict occurs after line 7 of Algorithm 3, it is detected by failure of the CAS in line 12 of Algorithm 3.

When the data store includes multiple linked lists, e.g., lock-free skip-list, items are inserted to the lists one at a time, from the bottom up. Only the bottom list is needed for correctness, while the others ensure the logarithmic search complexity. The implementation in this embodiment thus first inserts the new item to the bottom list atomically using Algorithm 3. It then adds the item to each higher list using a CAS operation as in line 12 of Algorithm 3, but with no need for a new time stamp at line 9 of Algorithm 3 or conflict detection as in lines 6 and 8 of Algorithm 3.

FIG. 12 is a flowchart of an exemplary process of concurrency control for an RMW operation in LSM data stores, according to an embodiment of the present teaching. This example shows part of an RMW operation traversing the bottom linked list. At 1202, a call from a thread for an RMW operation to a key k with a function f in a linked list of a LSM component. The linked list may be part of a single LSM component. In this embodiment, each entry of the linked list includes a key-value-time stamp triple, and the linked list is sorted in a lexicographical order. At 1204, in response to the call, a shared mode lock is set on the LSM components. For example, the shared mode lock is set on global pointers to each of the LSM components, including the memory component(s) and disk component(s). At 1206, an insertion point for the new node for the key k is located and stored in a local variable once the shared mode lock is set on the LSM components. At 1210, whether another thread inserted a new node for the key k during locating and storing the insertion point is determined. If the result of 1210 is positive, a conflict is detected, and the RMW operation is restarted from 1206. If the result of 1210 is negative, the process continues to 1212, where the succeeding node of the linked list is stored. At 1214, whether another thread inserted a new node for the key k before storing the succeeding node is checked. If the result of 1214 is positive, a conflict is detected, and the RMW operation is restarted from 1206. If the result of 1214 is negative, the process continues to 1216, where the new node is created for the key k. At 1217, a new time stamp is obtained for the new node. 1217 may be implemented by the get time stamp operation unit 520 of the RMW module 506 in FIG. 5. At 1218, the new value of the key k is set by applying the functionfto the retrieved current value of the key k. At 1220, the linked list is updated by a CAS operation. At 1222, whether the CAS operation fails is determined. If the result of 1222 is positive, a conflict is detected, and the RMW operation is restarted from 1206. If the result of 1222 is negative, the process continues to 1224, where the shared mode lock is released from the LSM components. For example, the shared mode lock is released from the global pointers to each of the LSM components. Blocks 1202-1224 correspond to the RMW module 506 and Algorithm 3.

The system and method for concurrency control in LSM data stores as described in the present teaching are evaluated versus a number of known solutions. The experiment platform is a Xeon E5620 server with two quad-core CPUs, each core with two hardware threads (16 hardware threads overall). The server has 48 GB of RAM and 720 GB SSD storage. The concurrency degree in the experiments varies from one to 16 worker threads performing operations; these are run in addition to the maintenance compaction thread. Four open-source LSM data stores are compared as known solutions: LevelDB, HyperLevelDB, RocksDB, and bLSM. HyperLevelDB and RocksDB are extensions of LevelDB that employ specialized synchronization to improve parallelism, and bLSM is a single-writer prototype that capitalizes on careful scheduling of merges. Unless stated otherwise, each LSM store is configured to employ an in-memory component of 128MB; the default values are used for all other configurable parameters.

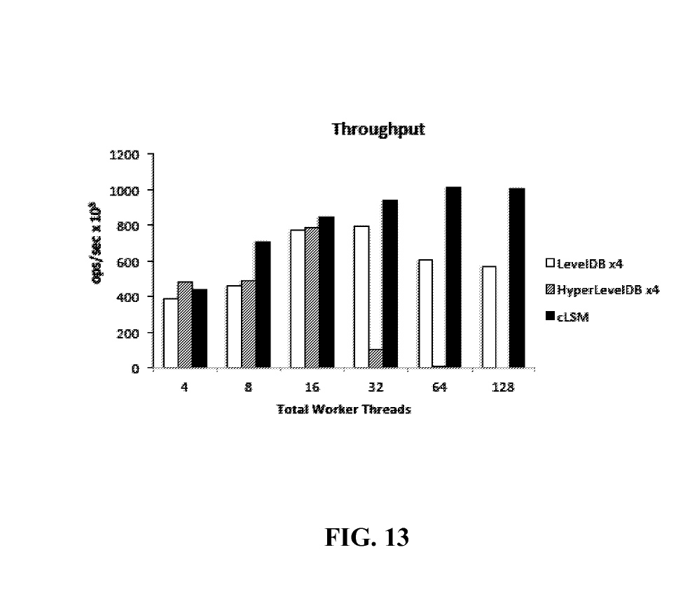

FIG. 13 compares the method and system in the present teaching with two known approaches regarding scalability with production workload. The resource-isolated configuration exercises LevelDB and HyperLevelDB with 4 separate partitions, whereas the resource-shared configuration evaluates the method and system in the present teaching with one big partition. In this example, the method and system of the present teaching are evaluated with one big partition versus LevelDB and HyperLevelDB with four small partitions, where each small partition's workload is based on a distinct production log, and the big partition is the union thereof. Each of the small partitions is served by a dedicated one quarter of the thread pool (resource separation), whereas the big partition is served by all worker threads (resource sharing). FIG. 13 shows that the method and system of the present teaching (cLSM) improved concurrency control scales better than partitioning, achieving a peak throughput of above 1 million operations/sec—approximately 25% above the competition.

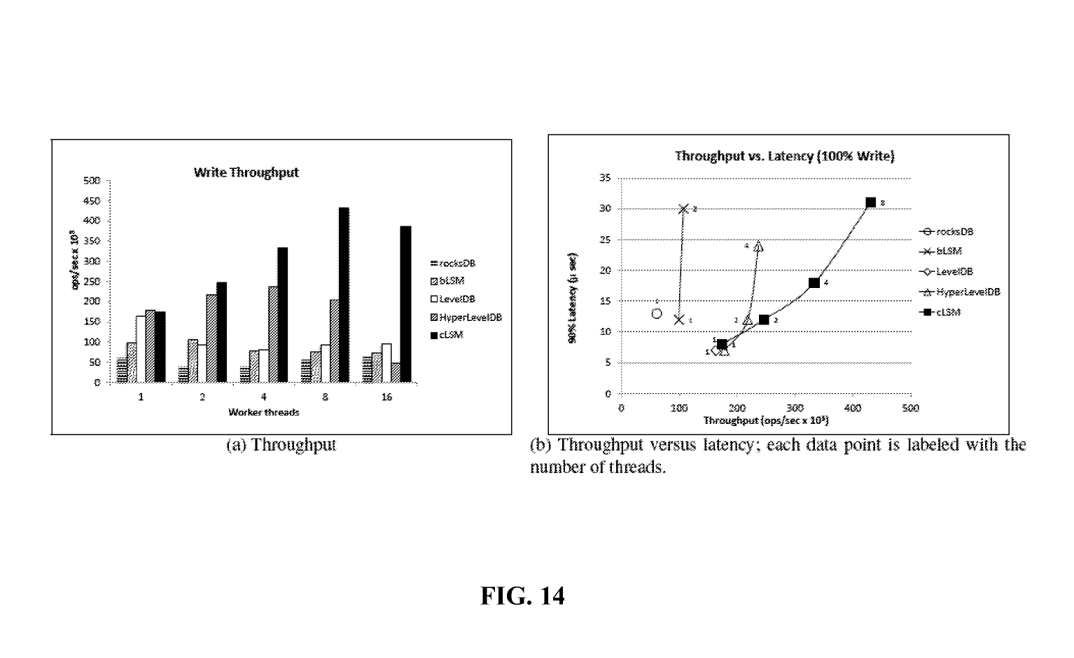

Write performance is then evaluated in FIG. 14. The experiment harnesses a 150 GB dataset (100× the size of the collection used to compare HyperLevelDB to LevelDB in the publicly available benchmark). The key-value pairs have 8-byte keys, and the value size is 256 bytes. The keys are drawn uniformly at random from the entire range. (Different distributions lead to similar results—the write performance in LSM stores is locality-insensitive.) FIG. 14(a) depicts the results in terms of throughput. LevelDB, HyperLevelDB, and the method and system of the present teaching (cLSM) start from approximately the same point, but they behave differently as we increase the number of threads. LevelDB, bLSM, and RocksDB are bounded by their single-writer architectures, and do not scale at all. HyperLevelDB achieves a 33% throughput gain with four worker threads, and deteriorates beyond that point. Throughput of the method and system of the present teaching (cLSM) scales 2.5× and becomes saturated at 8 threads. Its peak rate exceeds 430K writes/sec, in contrast with 240K for HyperLevelDB, 160K for LevelDB and 65K for RocksDB.

FIG. 14(b) refines the results by presenting the throughput-latency perspective, where the latency is computed for the 90-th percentile; other percentiles exhibit similar trends. For better readability, the experiments delineate improvement trends and omit points exhibiting decreasing throughput. FIG. 14(b) clearly marks the point in which each implementation saturates, namely, either achieves a slight throughput gain while increasing the latency by a factor of 2×-3× or achieves no gain at all.

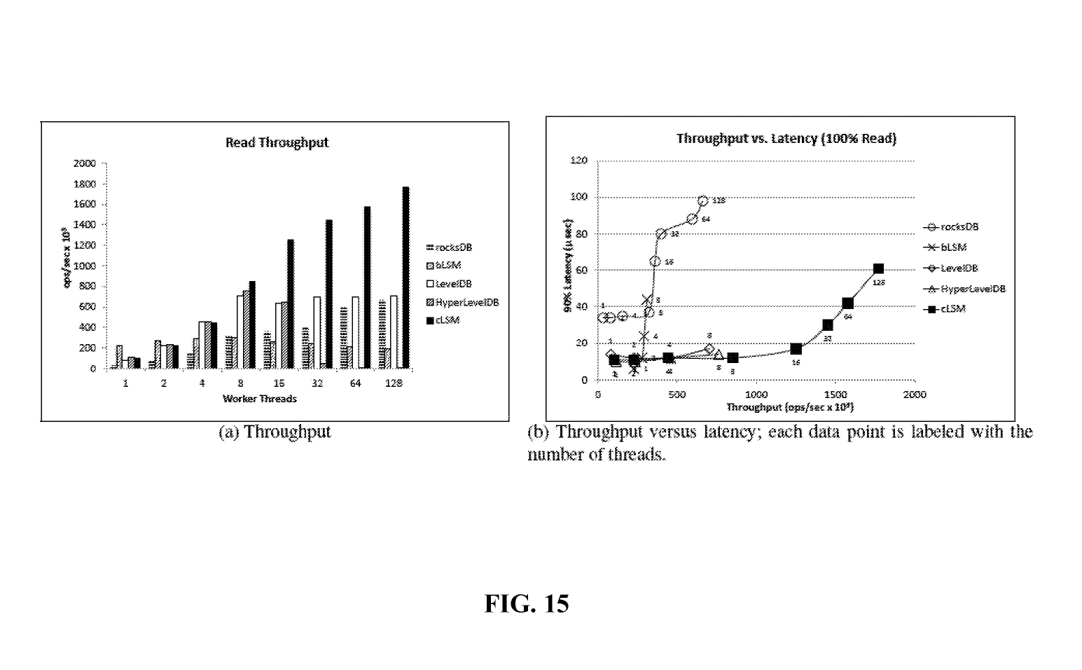

FIG. 15 evaluates performance in a read-only scenario. In this context, uniformly distributed reads would not be indicative, since the system would spend most of the time in disk seeks, devoiding the concurrency control optimizations of any meaning Hence, the experiments employ a skewed distribution that generates a CPU-intensive workload: 90% of the keys are selected randomly from “popular” blocks that comprise 10% of the database. The rest is drawn u.a.r. from the whole range. This workload is both dispersed and amenable to caching. All the following experiments exercise this distribution. FIG. 15(a) demonstrates throughput scalability. LevelDB and HyperLevelDB exhibit similar performance. Neither scales beyond eight threads, reflecting the limitations of LevelDB's concurrency control. On the other hand, the method and system of the present teaching (cLSM) and RocksDB scale all the way to 128 threads, far beyond the hardware parallelism (more threads than cores are utilized, since some threads block when reading data from disk). In all cases, RocksDB is slower than LevelDB and the method and system of the present teaching (cLSM). In this experiment, the peak throughput of the method and system of the present teaching (cLSM) is almost 1.8 million reads/sec—2.3× as much as the peak competitor rate.

Again, FIG. 15(b) shows the throughput-latency (90%) perspective. This figure emphasizes the scalability advantage of the method and system of the present teaching (cLSM): it shows that while RocksDB scales all the way, this comes at a very high latency cost, an order of magnitude higher than other LevelDB-based solutions with the same throughput (800K reads/sec).

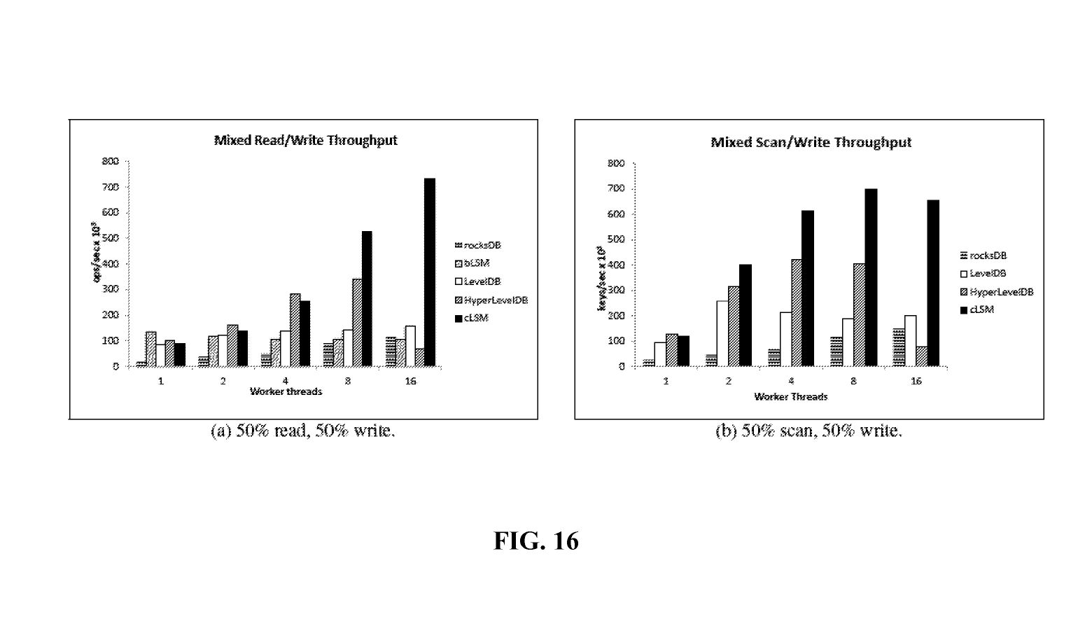

FIG. 16(a) depicts the throughput achieved by the different systems under a 1:1 read-write mix. The original LevelDB fails to scale, even though the writes are now only 50% of the workload. HyperLevelDB slightly improves upon that result, whereas the method and system of the present teaching (cLSM) fully exploit the software parallelism, scaling beyond 730K operations/sec with 16 worker threads.

FIG. 16(b) repeats the same experiment with reads replaced by range scans. (bLSM is not part of this evaluation because it does not directly support consistent scans). The size of each range is picked uniformly between 10 and 20 keys. The number of scan operations is therefore smaller than the number of writes by an order of magnitude, to maintain the balance between the number of keys written and scanned. The cumulative throughput is measured as the overall number of accessed keys. Similarly to the previous cases, the known solutions are slower than the method and system of the present teaching (cLSM) by more than 60%. Notice that scans are faster than read operations since in each scan operation, the scanned items are located close to the first item.

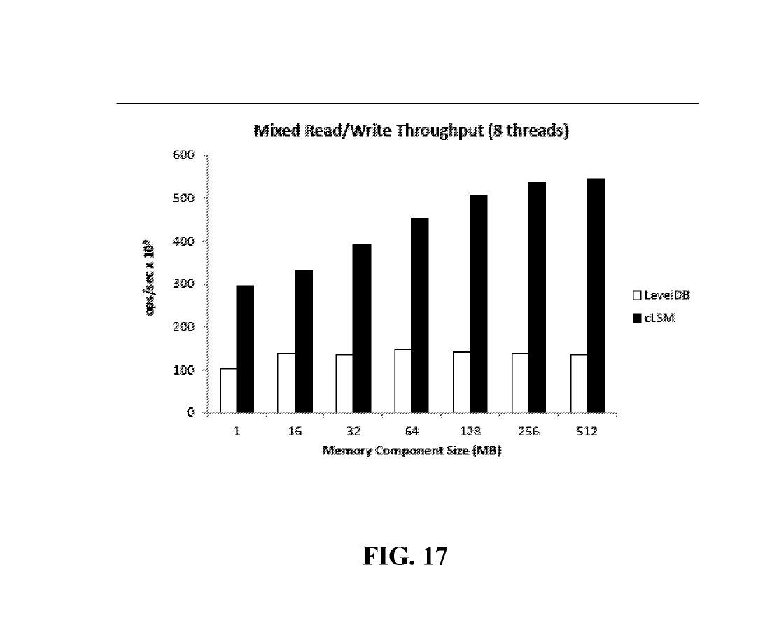

The next experiment evaluates how the system may benefit from additional RAM. FIG. 17 compares benefits of LevelDB's and the method and system of the present teaching (cLSM) from larger memory components, under the read-write workload, with eight working threads. LevelDB performs nearly the same for all sizes beyond 16 MB, whereas the method and system of the present teaching (cLSM) keep improving with the memory buffer growing to 512 MB. In general, LSM data stores may gain from increasing the in-memory component size thanks to better batching of disk accesses. However, this also entails slower in-memory operations. FIG. 17 shows that the method and system of the present teaching (cLSM) masks this added latency via its high degree of parallelism, which the less scalable alternatives fail to do.

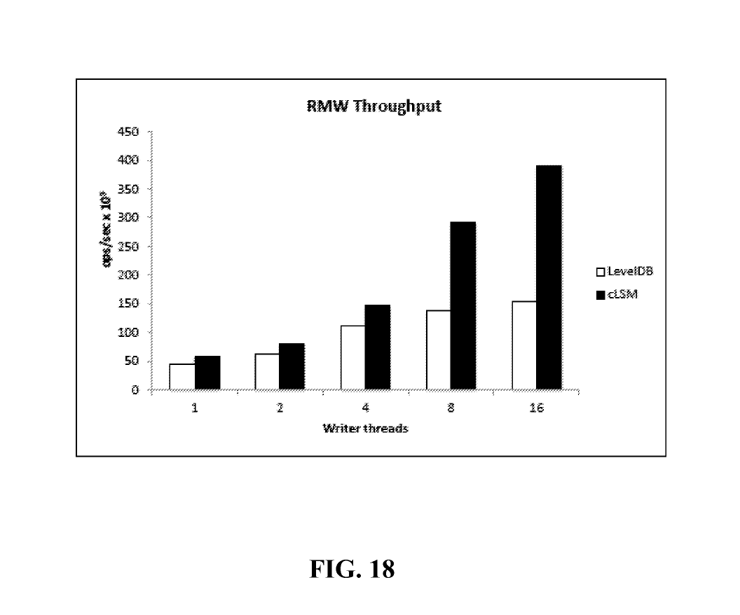

The next experiment explores the performance of atomic RMW operations. To establish a comparison baseline, LevelDB is with a textbook RMW implementation based on lock striping. The algorithm protects each RMW and write operations with an exclusive granular lock to the accessed key. The basic read and write implementations remain the same. The lock-striped LevelDB is compared with the method and system of the present teaching. The first workload under study is comprised solely of RMW operations. As shown in FIG. 18, the method and system of the present teaching (cLSM) scale to almost 400K operations/sec—a 2.5× throughput gain compared to the standard implementation. This volume is almost identical to the peak write load.

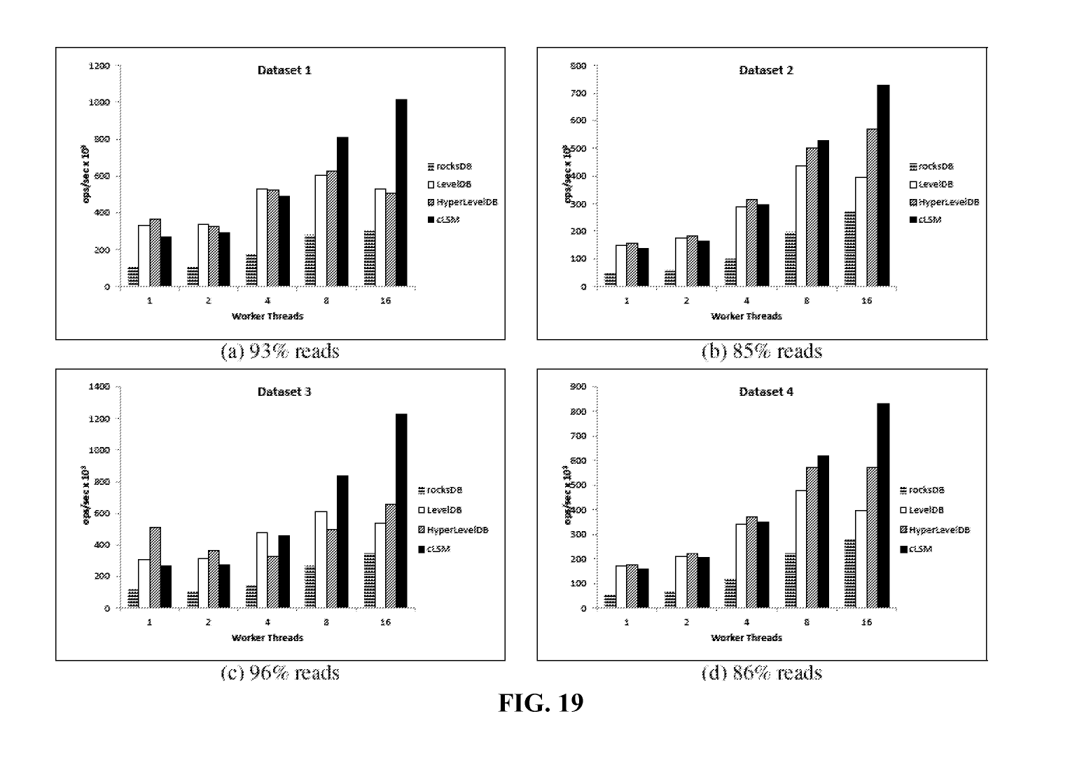

In the next experiment regarding production workloads, a set of 20 workloads logged in a production key-value store that serves some of the major personalized content and advertising systems on the web are studied. Each log captures the history of operations applied to an individual partition server. The average log size is 5 GB, which translates to approximately 5 million operations. The captured workloads are read-dominated (85% to 95% reads). The key distributions are heavy-tail, all with similar locality properties. In most settings, 10% of the keys stand for more than 75% of the requests, while the 1-2% most popular keys account for more than 50%. Approximately 10% of the keys are only encountered once. FIG. 19 depicts the evaluation results for four representative workloads. Although the method and system of the present teaching (cLSM) are slower than the known solutions with a small number of threads, its scalability is much better. These results are similar to the results shown in FIG. 16(a).

The above experiments demonstrate situations in which the in-memory access is the main performance bottleneck. Recently, the RocksDB project has shown that in some scenarios, the main performance bottleneck is disk-compaction. In these scenarios, a huge number of items is inserted (at once) into the LSM store, leading to many heavy disk-compactions. As a result of the high disk activity, the Cₘ component frequently becomes full before the C′ₘ component has been merged into the disk. This causes client operations to wait until the merge process completes.

The next experiment uses a benchmark to demonstrate this situation. In this benchmark, the initial database is created by sequentially inserting one billion items. During the benchmark, one billion update operations are invoked by the worker threads. The method and system of the present teaching are compared with RocksDB in this experiment. Although the method and system of the present teaching and RocksDB have different configurable parameters, some of these parameters appear in both configurations; for each parameter that appears in both, we configure cLSM to use the value used in RocksDB. These parameters include: size of in-memory component (128 MB), total number of levels (6 levels), target file size at level-1 (64 MB), and number of bytes in a block (64 KB).

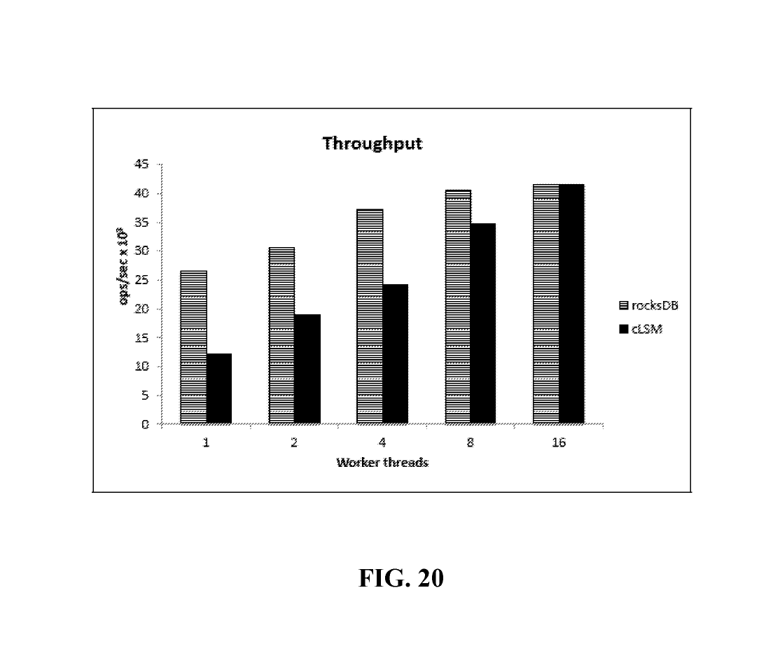

FIG. 20 depicts the results of this benchmark. The results show that both the method and system of the present teaching (cLSM) and RocksDB scale all the way to 16 worker threads (despite the fact that disk-compaction is running most of the time). At 16 threads, the method and system of the present teaching (cLSM) become equivalent to RocksDB. Notice that RocksDB uses an optimized compaction algorithm that utilizes several background threads, whereas the method and system of the present teaching (cLSM) use a simpler compaction algorithm executed by a single background thread. It should be noted that RocksDB's compaction optimizations are orthogonal to our improved parallelism among worker threads.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

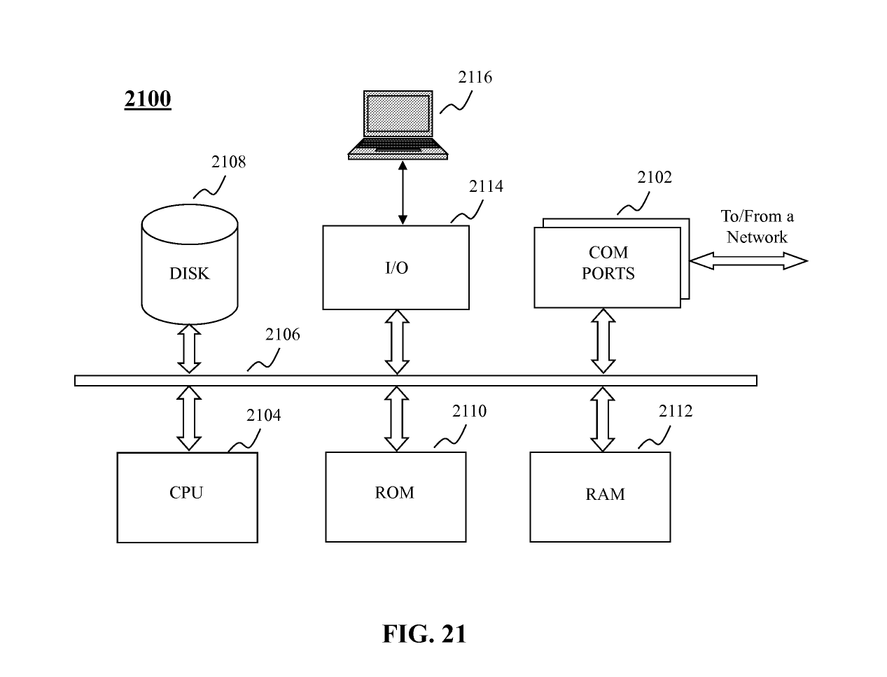

FIG. 21 depicts the architecture of a computer which can be used to implement a specialized system incorporating the present teaching. The computer may be a general-purpose computer or a special purpose computer. This computer 2100 can be used to implement any components of the LSM data store concurrency control architecture as described herein. Different components of the system can all be implemented on one or more computers such as computer 2100, via its hardware, software program, firmware, or a combination thereof.

The computer 2100, for example, includes COM ports 2102 connected to and from a network connected thereto to facilitate data communications. The computer 2100 also includes a CPU 2104, in the form of one or more processors, for executing program instructions. The exemplary computer platform includes an internal communication bus 2106, program storage and data storage of different forms, e.g., disk 2108, read only memory (ROM) 2110, or random access memory (RAM) 2112, for various data files to be processed and/or communicated by the computer, as well as possibly program instructions to be executed by the CPU 2104. The computer 2100 also includes an I/O component 2114, supporting input/output flows between the computer and other components therein such as user interface elements 2116. The computer 2100 may also receive programming and data via network communications.

Hence, aspects of the method of LSM data store concurrency control, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on a computing device which has at least one processor and storage for concurrency control in log-structured merge (LSM) data stores, the method comprising:
receiving a call from a thread for writing a value to a key of LSM components;
setting a shared mode lock on the LSM components in response to the call;
writing the value to the key once the shared mode lock is set on the LSM components; and
releasing the shared mode lock from the LSM components after the value is written to the key.

2. The method of claim 1, wherein the shared mode lock is set on global pointers to each of the LSM components.

3. The method of claim 1, further comprising:
receiving a call from a thread for reading the value of the key;
locating the key from a current memory component of the LSM components, a previous memory component of the LSM components, or a disk component of the LSM components, in this order, without setting a lock on the LSM components; and
returning the value of the located key.

4. A method implemented on a computing device which has at least one processor and storage for concurrency control in log-structured merge (LSM) data stores, the method comprising:
receiving a call for merging a current memory component of LSM components with a current disk component of the LSM components;
setting an exclusive mode lock on the LSM components in response to the call;
updating a pointer to the current memory component and a pointer to a new memory component of the LSM components once the first exclusive mode lock is set on the LSM components;
releasing the exclusive mode lock from the LSM components after the pointers to the current and new memory components are updated;
merging the current memory component with the current disk component to generate a new disk component of the LSM components;
setting the exclusive mode lock on the LSM components once the new disk component is generated;
updating a pointer to the new disk component once the second exclusive mode lock is set on the LSM components; and
releasing the exclusive mode lock from the LSM components after the pointer to the new disk components is updated.

5. The method of claim 4, further comprising:
removing the pointer to a previous memory component once the second exclusive mode lock is set on the LSM components.

6. The method of claim 4, wherein each of the first and second exclusive mode locks is set on global pointers to each of the LSM components.

7. A method implemented on a computing device which has at least one processor and storage for concurrency control in log-structured merge (LSM) data stores, the method comprising:
receiving a call from a thread for writing a value to a key of LSM components;
setting a shared mode lock on the LSM components in response to the call;
obtaining a time stamp that exceeds the latest snapshot's time stamp once the shared mode lock is set on the LSM components;
writing the value to the key with the obtained time stamp; and
releasing the shared mode lock from the LSM components after the value is written to the key with the obtained time stamp.

8. The method of claim 7, wherein the shared mode lock is set on global pointers to each of the LSM components.

9. The method of claim 7, wherein
the latest snapshot's time stamp is earlier than all active time stamps; and
a time stamp is active if a thread that adds the time stamp is still running

10. A method implemented on a computing device which has at least one processor and storage for concurrency control in log-structured merge (LSM) data stores, the method comprising:
receiving a call from a thread for getting a snapshot of LSM components;
setting a shared mode lock on the LSM components in response to the call;
obtaining a time stamp that is earlier than all active time stamps once the shared mode lock is set on the LSM components;
releasing the shared mode lock from the LSM components after the time stamp is obtained; and
returning the obtained time stamp as a snapshot handle.

11. The method of claim 10, further comprising:
updating an active snapshot list with the obtained time stamp.

12. The method of claim 10, wherein a time stamp is active if a thread that adds the time stamp is still running

13. The method of claim 10, further comprising:
receiving a call for merging a current memory component of the LSM components with a current disk component of the LSM components;
setting an exclusive mode lock on the LSM components in response to the call for merging;
updating a pointer to the current memory component and a pointer to a new memory component of the LSM components once the exclusive mode lock is set on the LSM components;
finding a minimal active snapshot time stamp;
releasing the exclusive mode lock from the LSM components after the minimal active snapshot time stamp is found; and
returning the minimal active snapshot time stamp.

14. The method of claim 13, further comprising:
merging the current memory component with the current disk component based on the minimal active snapshot time stamp to generate a new disk component of the LSM components.

15. A method implemented on a computing device which has at least one processor and storage for concurrency control in log-structured merge (LSM) data stores, the method comprising:
receiving a call from a thread for a read-modify-write (RMW) operation to a key with a function in a linked list of a LSM component;
setting a shared mode lock on LSM components in response to the call;
locating and storing an insertion point of a new node for the key in a local variable once the shared mode lock is set on the LSM components;
determining whether another thread inserts a new node for the key during locating and storing the insertion point;
if the result of the determining is negative, storing a succeeding node of the linked list;
checking whether another thread inserts a new node for the key before storing the succeeding node; and
if the result of the checking is negative, creating the new node of the linked list for the key, obtaining a new time stamp for the new node; and setting a new value of the key by applying the function to a current value of the key.

16. The method of claim 15, further comprising:
updating the linked list by a compare-and-swap (CAS) operation after setting the new value of the key;
determining whether the CAS operation fails; and
if the result of the determining is negative, releasing the shared mode lock from the LSM components.

17. The method of claim 15, wherein the shared mode lock is set on global pointers to each of the LSM components.

18. The method of claim 15, further comprising:
if the result of the determining or the result of the checking is positive, restarting the RMW operation to the key.

19. The method of claim 15, wherein each entry of the linked list includes a key-value-time stamp triple.

20. The method of claim 15, wherein the linked list is sorted in a lexicographical order.
